(19) United States
(12) Patent Application Publication
(10) Pub. No.: US 2023/0210253 A1
(43) Pub. Date: Jul. 6, 2023

(54) WORK PLATFORM SYSTEM

(71) Applicant: Bell Textron Inc., Fort Worth, TX (US)

(72) Inventors: Michael Ross Wilkinson, North Richland Hills, TX (US); James Everett Kooiman, Fort Worth, TX (US); Clegg Benjamin Brian Smith, Fort Worth, TX (US); Jeffrey Matthew Williams, Aledo, TX (US); Tjepke Heeringa, Dallas, TX (US); David G. Carlson, North Richland Hills, TX (US)

(73) Assignee: Bell Textron Inc., Fort Worth, TX (US)

(21) Appl. No.: 17/569,152

(22) Filed: Jan. 5, 2022

(51) Int. Cl. A47B 5/00; B64D 11/00

(52) U.S. Cl. CPC A47B 5/00; B64D 11/00; A47B 2200/0066

(57) ABSTRACT

An aircraft includes a fuselage having a former therein and a work platform system. The work platform system includes a platform that is moveable between a stowed configuration and a deployed configuration. The work platform system also has a hinge pin received by the platform. A platform stop is carried by the former and configured to inhibit rotation of the platform about the hinge pin when the platform is in the deployed configuration. The hinge pin is carried by the former.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

It is common for aircraft workers to need access to portions of an aircraft that are vertically out of reach without the use of ladders, lifts, and weight-bearing wings. Some aircraft do not have inherent features, such as weight-bearing wings, capable of supporting a worker and the worker's tools and equipment. Further, even when aircraft do have inherent features capable of supporting substantial amounts of weight, those features typically do not provide a flat surface or sufficient space for comfortably accommodating a worker and a worker's tools and equipment. Still further, conventional methods of supporting a worker while working on aircraft often involve extra equipment, such as lifts and cages for supporting a worker, however, such extra equipment is not always located convenient to an aircraft when needed. Accordingly, there remains a need for a work platform that is better suited than typical integral aircraft features and is more conveniently available to an aircraft regardless of a location of the aircraft.

### BRIEF DESCRIPTION OF THE DRAWINGS

FIG. 1 is a side view of an aircraft according to an embodiment of this disclosure having a work platform system according to an embodiment of this disclosure.

FIG. 2 is an oblique view of a portion of the aircraft of FIG. 1 showing the work platform system in a stowed configuration.

FIG. 3 is an oblique view of a portion of the aircraft of FIG. 1 showing the work platform system in a deployed configuration.

FIG. 4 is an oblique view of a portion of the work platform system of FIG. 1 in isolation.

FIG. 5 is an oblique exploded view of the portion of the work platform system of FIG. 4.

FIG. 6 is a front view of the portion of the work platform system of FIG. 4.

FIG. 7 is a cross-sectional side view of the portion of the work platform system of FIG. 4.

FIG. 8 is a cross-sectional top view of the portion of the work platform system of FIG. 4.

FIG. 9 is a front view of a portion of the aircraft of FIG. 1 showing the work platform system in a stowed configuration.

FIG. 10 is a cross-sectional top view of the portion of the aircraft of FIG. 1 showing details of a hinged connection.

FIG. 11 is a detail view of a portion of the view of FIG. 10.

FIG. 12 is an oblique view of a portion of the aircraft of FIG. 1 showing a rear view of the work platform system in a stowed position.

FIG. 13 is a partial cross-sectional side view of the aircraft of FIG. 1 showing the work platform system in both a stowed configuration and a deployed configuration.

### DETAILED DESCRIPTION

In this disclosure, reference may be made to the spatial relationships between various components and to the spatial orientation of various aspects of components as the devices are depicted in the attached drawings. However, as will be recognized by those skilled in the art after a complete reading of this disclosure, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

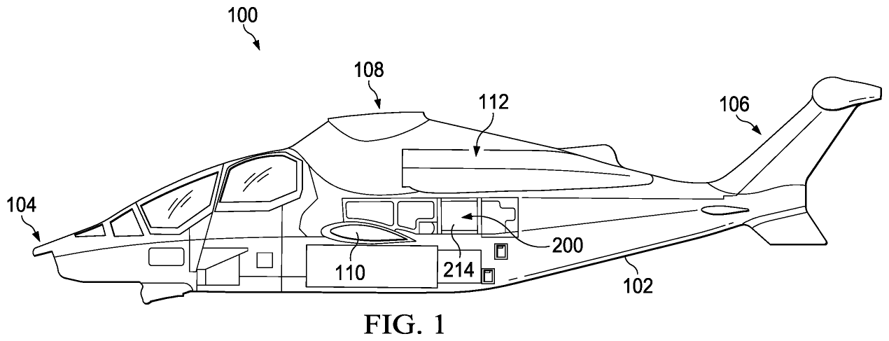

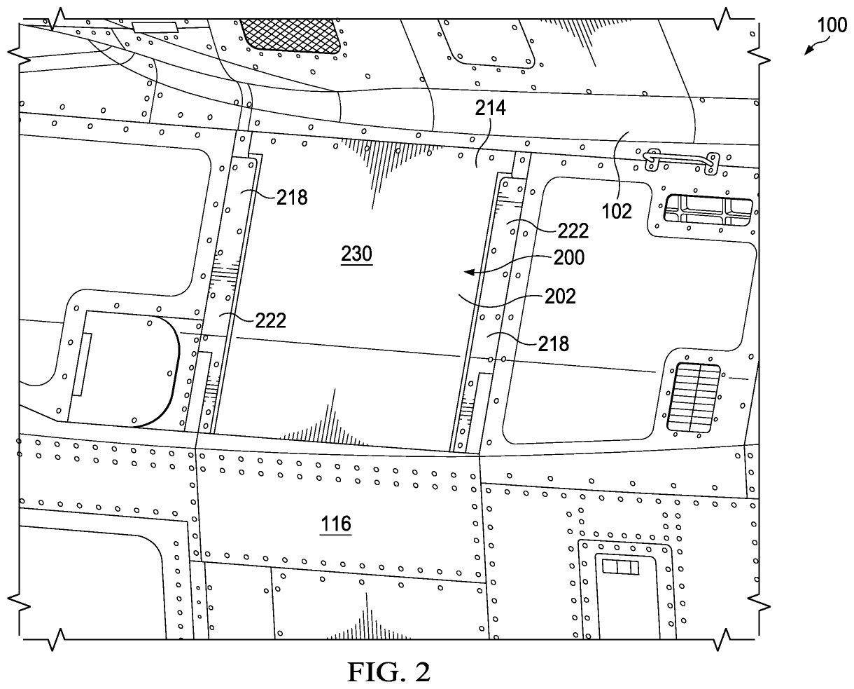

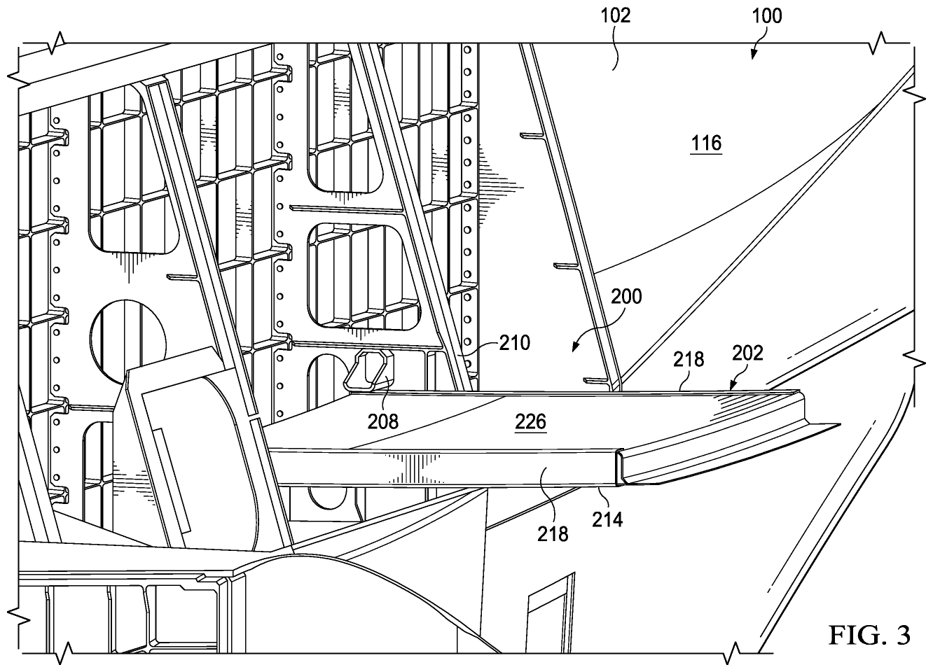

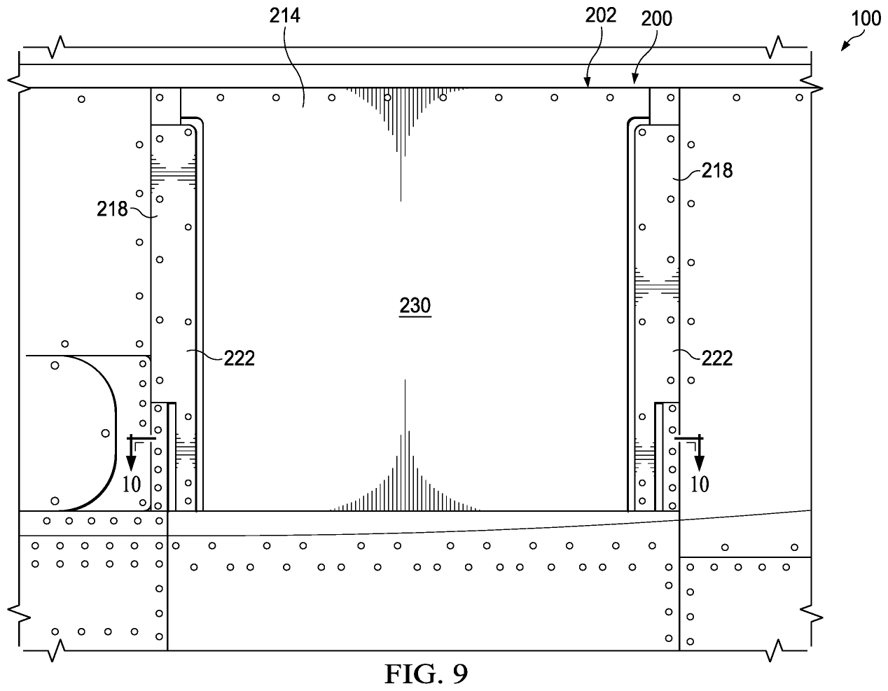

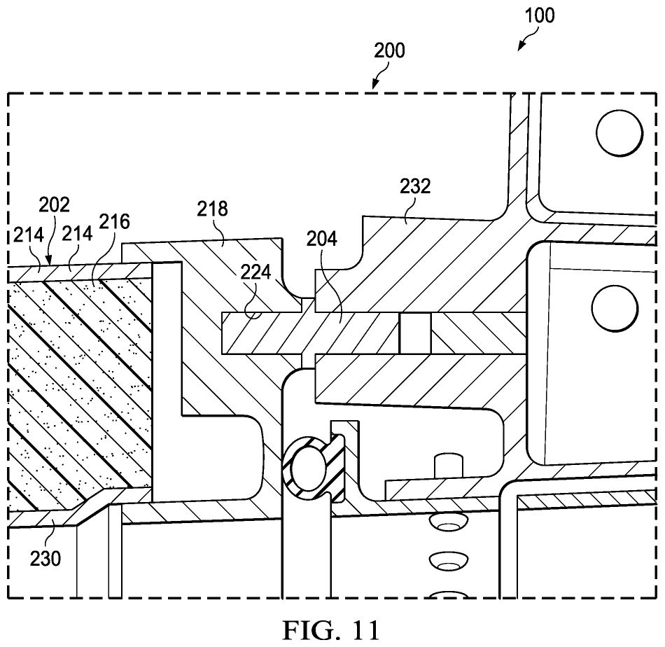

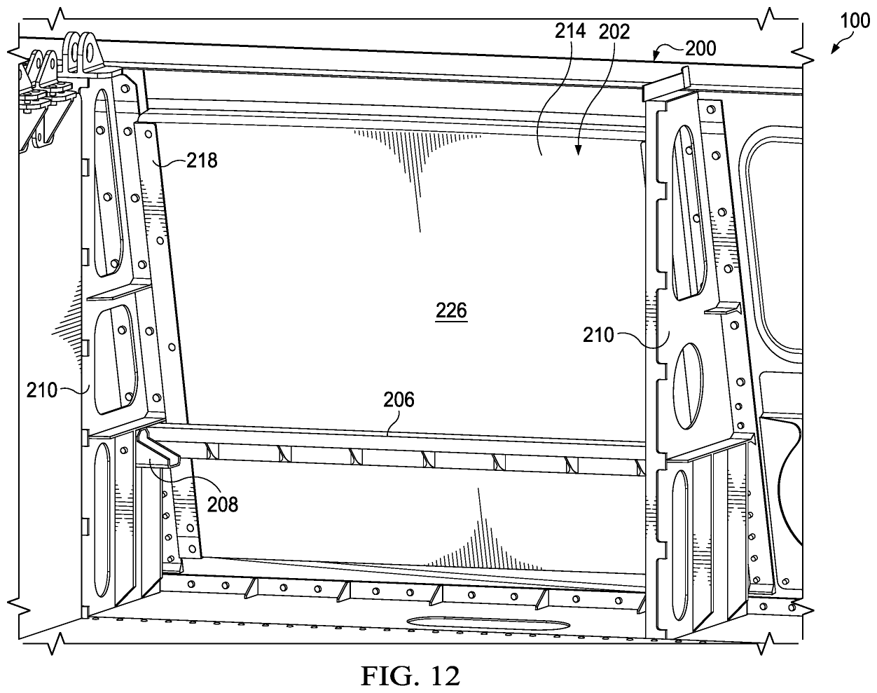

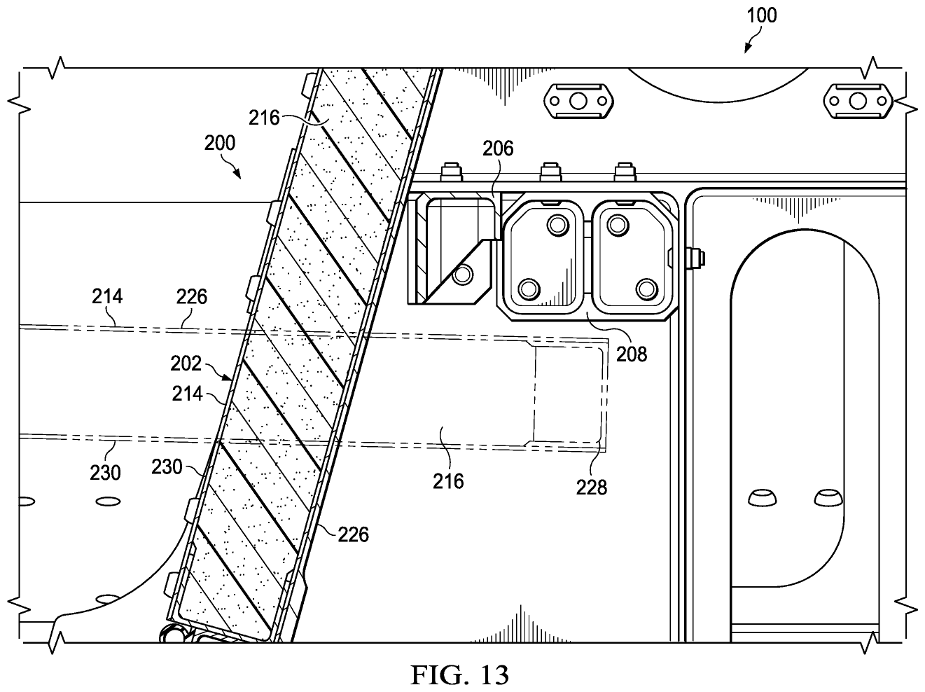

Referring now to FIGS. 1-3 and 9-13, an aircraft 100 is shown as comprising a fuselage 102, a nose 104, a tail 106, a rotor region 108, a wing 110, and an engine region 112. In some cases, such as, but not limited to, scenarios where access to one or more of rotor region 108 and engine region 112 is needed, a work platform system (WPS) 200 carried by aircraft 100 can be utilized. Most generally, and as will be described below, WPS 200 is disposed aft relative to at least a portion of rotor region 108 and is conveniently located a long an exterior of fuselage 102 so that upon deployment from a stowed configuration a user can safely rest atop the WPS 200 and gain access to rotor region 108 or engine region 112. FIGS. 1, 2, and 9-13 show WPS 200 in a stowed configuration wherein WPS 200 presents minimal aerodynamic drag during movement of aircraft 100. FIGS. 3 and 13 show WPS 200 in a deployed configuration wherein WPS 200 presents a stable support surface for a user to rest atop while accessing rotor region 108 or engine region 112.

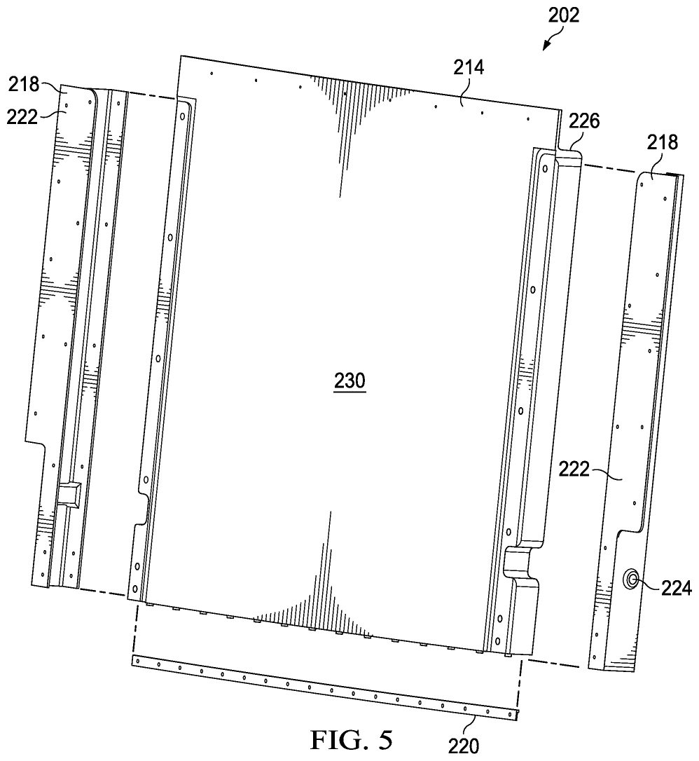

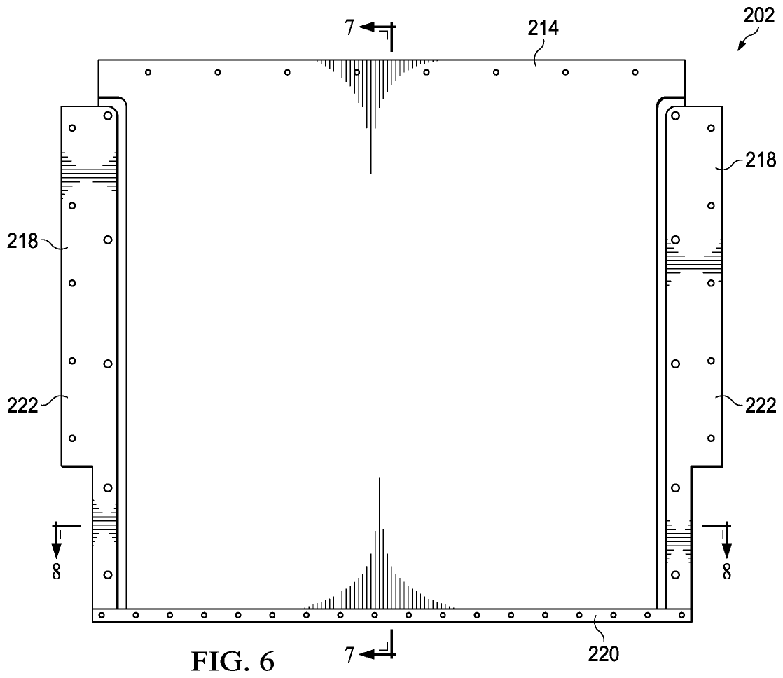

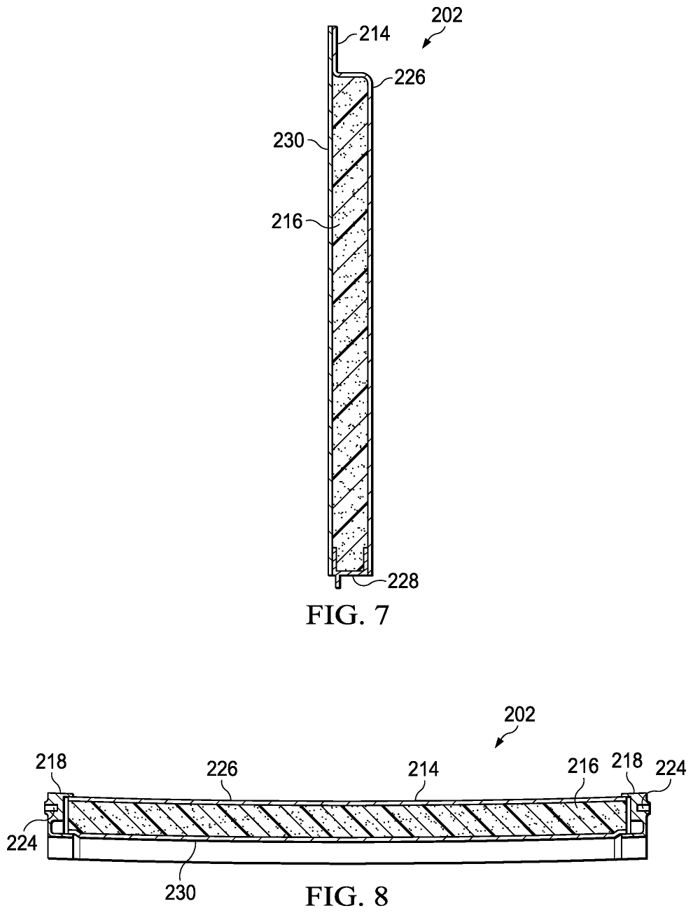

Referring now to FIGS. 3-13, WPS 200 generally comprises a platform 202, hinge pins 204, platform barriers 206, and platform stops 208. In this embodiment, hinge pins 204 are carried by structural elements, namely, formers 210 which provide mechanical strength to fuselage 102 and support outer fuselage skins 116. Hinge pins 204 are used to rotatably secure platform 202 relative to formers 210. Platform barriers 206 are carried by formers 210 and serve as a physical barrier to prevent platform 202 from rotating about hinge pins 204 to a position beyond a stowed configuration where an upper portion of platform 202 is received too far within fuselage 102 and not aligned with an exterior of fuselage 102. Similarly, platform stops 208 are carried by formers 210 and are used to selectively stop rotation of platform 202 beyond in a predetermined deployed configuration where platform 202 is generally parallel to the ground on with aircraft 100 rests.

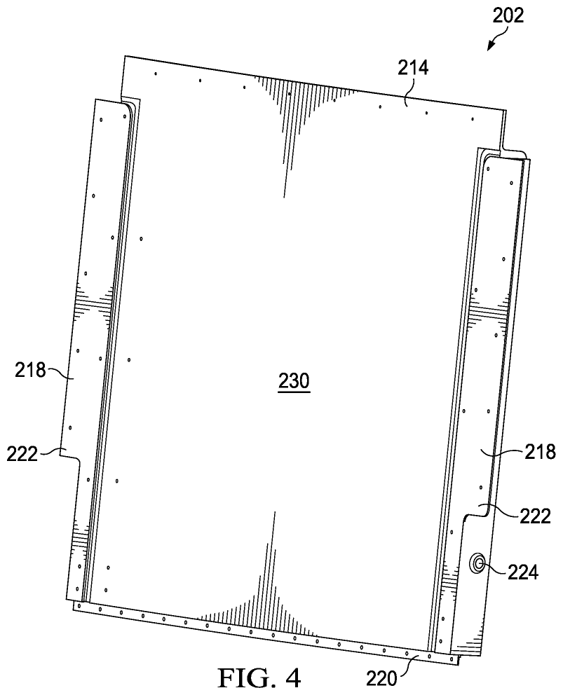

Referring now to FIGS. 4-8, platform 202 is shown in isolation. Platform 202 generally comprises an outer skin 214 surrounding an inner core 216. Skin 214 can comprise one or more components that together form a substantially unitary covering that envelopes core 216 except for lateral sides of core 216. Core 216 is a substantially incompressible lightweight component that serves to provide overall structural and bending stiffness to platform 202 so that forces applied to skin 214 can be passed through core 216. In this embodiment, platform 202 is generally a rigid structure and the rigidity of the structure can be provided in part by joining skin 214 and core 216 using bonding processes and/or mechanical fasteners. In this embodiment, platform 202 comprises a molded plastic. Platform 202 further comprises hinge fittings 218 that accept lateral sides of platform 202. In this embodiment, hinge fittings 218 are metallic and generally comprise longitudinal elements that each comprise a U-shaped channel configured to receive a lateral side of skins 214 and core 216. Hinge fittings 218 can be bonded to outer skin 214 and/or mechanically fastened to outer skin 214 using mechanical fasteners. Platform 202 further comprises a seal retainer 220 attached to a lower side of skin 214. In some embodiments, seal retainer 220 is a rigid component configured to carry a relatively softer sealing component that is configured to prevent particulate matter and moisture from entering fuselage 102 between outer fuselage skin 116 and platform 202. Hinge fittings 218 further comprise mounting flanges 222 that serve as a stop for limiting platform 202 to rotating too far into fuselage, such as rotating beyond a predetermined stowed position wherein an exterior of platform 202 is substantially aligned with outer fuselage skin 116 adjacent WPS 200. Mounting flanges 222 further comprise pin receptacles configured to receive hinge pins 204. In this embodiment, platform 202 can be rotated about hinge pins 204 between a stowed configuration and a deployed configuration. Although other embodiments are contemplated, skin 214 comprises at least three plastic components bonded together, a rear wall 226, a lower channel portion 228, and a front plate 230.

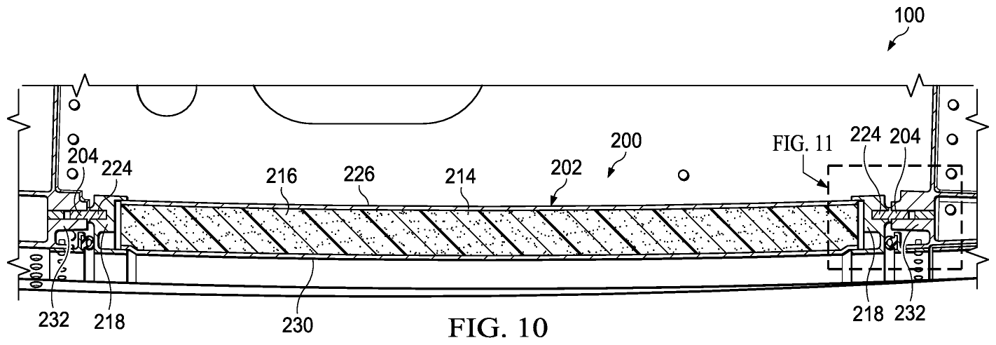

Referring now to FIGS. 10-13, hinge pins 204 are secured relative to fuselage 102 using pin mounts 232 which are attached to formers 210. Accordingly, the weight of platform 202 and anything supported by platform 202, such as, but not limited to, users, tools, and other equipment, is supported by formers 210. More specifically, the weight force of platform 202 and the weight of things supported by platform 202 is transmitted from platform 202 to hinge pins 204 and from hinge pins 204 to formers 210. Further, platform 202 is prevented from rotating beyond the stowed configuration by platform barriers 206 which are connected between adjacent formers 210. Similarly, platform 202 is prevented from rotating beyond the deployed configuration by platform stops 208. Put another way, platform 202 is free to be rotated about hinge pins 204 between a position where platform contacts platform barriers 206 (stowed position) and a position where platform contacts platform stops 208 (deployed position).

It will further be appreciated that while the systems disclosed herein are discussed in the context of providing work platform system in an aircraft, the same essential components and methodologies can be utilized in any other system to provide a work platform that can be deployed and stowed. Further, it will be appreciated that the location of hinge pins can be provided at different locations to provide a different axis of rotation location and a different amount of stability when putting weight on the platform. In the embodiment shown, WPS 200 provides a significant benefit by integrating a work platform into aircraft 100 so that additional work platform equipment is not needed to service or inspect aircraft 100. A WPS substantially similar to WPS 200 can be provided elsewhere on aircraft 100 or on other vehicles or equipment so long as a suitable load path can be provided. For example, in some cases, a structural skin of an aircraft or other vehicle may be sufficiently rigid and strong to allow mounting of hinge pins, platforms, and stops to structural skins rather than to formers or other structural supports internal to a fuselage.

Still further, embodiments disclosed herein can provide a WPS comprising a hinged platform substantially anywhere along the outer surface of a fuselage, even complex curved surfaces, while still minimizing gaps to reduce aerodynamic degradation and/or inefficiencies. Further, it will be appreciated that the interior work surface of a WPS can comprise any suitable shape, including shapes selected to improve human factors and user comfort. The interior work surface can be provided as desired without substantial consideration or dependence on the exterior profile of the fuselage, such as by providing a substantially flat work surface while the WPS is associated with a complex profile, such as, but not limited to, an organic or natural fuselage profile.

At least one embodiment is disclosed, and variations, combinations, and/or modifications of the embodiment(s) and/or features of the embodiment(s) made by a person having ordinary skill in the art are within the scope of this disclosure. Alternative embodiments that result from combining, integrating, and/or omitting features of the embodiment(s) are also within the scope of this disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 95 percent, 98 percent, 99 percent, or 100 percent. Moreover, any numerical range defined by two R numbers as defined in the above is also specifically disclosed.

Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. Also, the phrases “at least one of A, B, and C” and “A and/or B and/or C” should each be interpreted to include only A, only B, only C, or any combination of A, B, and C.

What is claimed is:

1. A work platform system, comprising:
a platform moveable between a stowed configuration and a deployed configuration;
a hinge pin received by the platform; and
a platform stop configured to inhibit rotation about the hinge pin when the platform is in the deployed configuration.

2. The work platform system of claim 1, further comprising:
a platform barrier configured to inhibit rotation of the platform about the hinge pin when the platform is in the stowed configuration.

3. The work platform system of claim 1, the platform comprising:
an outer skin; and
an inner core disposed within the outer skin.

4. The work platform system of claim 3, the outer skin comprising:
a rear wall;
a front plate; and
a lower channel portion disposed between the rear wall and the front plate.

5. The work platform system of claim 4, wherein at least two of the rear wall, the front plate, and the lower channel portion are bonded together.

6. The work platform system of claim 3, wherein the outer skin is bonded to the inner core.

7. The work platform system of claim 3, the platform further comprising:
a pair of hinge fittings configured to receive the outer skin therebetween.

8. The work platform system of claim 7, wherein the hinge fittings each comprise a substantially U-shaped profile configured to receive the outer skin therein.

9. An aircraft, comprising:
a fuselage comprising a former therein; and
a work platform system, comprising:
a platform moveable between a stowed configuration and a deployed configuration;
a hinge pin received by the platform; and
a platform stop carried by the former and configured to inhibit rotation about the hinge pin when the platform is in the deployed configuration;
wherein the hinge pin is carried by the former.

10. The aircraft of claim 9, further comprising:
a platform barrier carried by the former and configured to inhibit rotation of the platform about the hinge pin when the platform is in the stowed configuration.

11. The aircraft of claim 9, the platform comprising:
an outer skin; and
an inner core disposed within the outer skin.

12. The aircraft of claim 11, the outer skin comprising:
a rear wall;
a front plate; and
a lower channel portion disposed between the rear wall and the front plate.

13. The aircraft of claim 12, wherein at least two of the rear wall, the front plate, and the lower channel portion are bonded together.

14. The aircraft of claim 11, wherein the outer skin is bonded to the inner core.

15. The aircraft of claim 11, the platform further comprising:
a pair of hinge fittings configured to receive the outer skin therebetween.

16. The aircraft of claim 15, wherein the hinge fittings each comprise a substantially U-shaped profile configured to receive the outer skin therein.

17. The aircraft of claim 9, wherein when the platform is in the stowed position, an outer profile of the platform is substantially complementary to an outer profile of the fuselage so that aerodynamic drag attributable to the platform is low.

18. A method of operating a work platform system of an aircraft, comprising:
providing a platform that is rotatable between a stowed configuration and a deployed configuration;
providing a hinge pin supported by a former of a fuselage of the aircraft; and
rotating the platform about the hinge pin to a deployed configuration where further rotation of the platform is prevented by a platform stop carried by the former.

19. The method of claim 18, further comprising
rotating the platform away from the deployed configuration to a stowed configuration where further rotation of the platform is prevented by a platform barrier carried by the former.

20. The method of claim 19, wherein an outer profile of the platform is substantially complementary to an outer profile of the fuselage so that aerodynamic drag attributable to the platform is low.
